(19) United States
(12) Patent Application Publication
(10) Pub. No.: US 2024/0283499 A1
(43) Pub. Date: Aug. 22, 2024

(54) PRECODING MATRIX DETERMINATION METHODS, USER EQUIPMENT, AND BASE STATION

(71) Applicant: Beijing Xiaomi Mobile Software Co., Ltd., Beijing (CN)

(72) Inventors: Dong CHEN, Beijing (CN); Liangang CHI, Beijing (CN)

(73) Assignee: Beijing Xiaomi Mobile Software Co., Ltd., Beijing (CN)

(21) Appl. No.: 18/569,877

(22) PCT Filed: Jun. 15, 2021
(86) PCT No.: PCT/CN2021/100213

§ 371 Date: Dec. 13, 2023

(51) Int. Cl. H04B 7/0456; H04W 72/044

(52) U.S. Cl. CPC H04B 7/0456; H04W 72/044

(57) ABSTRACT

Provided are precoding matrix determination methods, a user equipment, a base station, and media. According an aspect, the method includes: receiving reception pilot information T from a user equipment (UE), and determining a pilot vector T₂ based on the reception pilot information T; determining a channel matrix H based on the pilot vector T₂, and determining a conversion matrix He based on the channel matrix H; and determining a precoding matrix W corresponding to the channel matrix H based on the conversion matrix Hₚ.

### CROSS REFERENCE TO RELATED APPLICATIONS

This application is a U.S. national phase application of International Application No. PCT/CN2021/100213, filed on Jun. 15, 2021, the disclosure of which is incorporated herein by reference in its entirety for all purposes.

### BACKGROUND

In a multi-user multiple input multiple output (MU-MIMO) system, it is usually necessary to determine a precoding matrix, so that data to be transmitted can be preprocessed by the precoding matrix before being transmitted to a data receiver. Thus, the data transmission process can adapt to changes in channel state and improve the performance of data transmission.

In related technologies, a precoding matrix determination method mainly includes: a precoding matrix is determined based on a black box network or an unfolding network. Specifically, channel estimation is performed at abase station end to construct one or more training data sets, and then a black box network structure or an unfolding network structure that can learn a mapping relationship from channel state information to the precoding matrix is constructed at the base station end. Based on the training data sets, the black box network structure or the unfolding network structure is trained to obtain a trained network structure, and the precoding matrix is determined based on the trained network structure.

The method of determining the precoding matrix based on the black box network lacks interpretability, and has a poor mapping capability for nonlinear operations (for example, inverse operation), resulting in poor calculation effect. Moreover, explicit channel state information needs to be obtained, which affects the calculation performance of the precoding matrix. In addition, the network design in the method of determining the precoding matrix based on unfolding network is complex, and a deep learning training framework cannot be used, so the efficiency is low. In addition, the explicit channel state information also needs to be obtained, which affects the calculation performance of the precoding matrix.

### SUMMARY

The present disclosure relates to the field of communication technology, and in particular to precoding matrix determination methods, a user equipment, and a base station.

A precoding matrix determination method according to a first embodiment of the present disclosure is applied to a base station, and includes: receiving reception pilot information T from a user equipment (UE), and determining a pilot vector T₂ based on the reception pilot information T; determining a channel matrix H based on the pilot vector T₂, and determining a conversion matrix Hₚ based on the channel matrix H; and determining a precoding matrix W corresponding to the channel matrix H based on the conversion matrix Hₚ.

A precoding matrix determination method according to a second embodiment of the present disclosure is applied to a user equipment (UE), and includes: determining transmission pilot information P based on pilot data s; and transmitting the transmission pilot information P to a base station.

A user equipment (UE) according to a third embodiment of the present disclosure, including: a transceiver; a memory; and a processor, respectively connected to the transceiver and the memory, configured to control wireless signal transmission and reception of the transceiver by executing computer executable instructions on the memory, and capable of implementing the method according to the above second embodiment.

A base station according to a fourth embodiment of the present disclosure, including: a transceiver; a memory; and a processor, respectively connected to the transceiver and the memory, configured to control wireless signal transmission and reception of the transceiver by executing computer executable instructions on the memory, and capable of implementing the method according to the above first embodiment.

For additional aspects and advantages of the present disclosure, a part of them will be set forth in the following description, and another part of them will be apparent according to the following description or be learned through putting the present disclosure into practice.

### BRIEF DESCRIPTION OF THE DRAWINGS

The above and/or additional aspects and advantages of the present disclosure will become apparent and readily understood according to the following description of the examples in conjunction with the accompanying drawings.

FIG. 1 is a flowchart of a precoding matrix determination method provided in an example of the present disclosure.

FIG. 2 is a schematic structural diagram of a second sub-network provided in an example of the present disclosure.

FIG. 3 is a schematic structural diagram of a third sub-network provided in an example of the present disclosure.

FIG. 4 is a schematic structural diagram of a fourth sub-network provided in an example of the present disclosure.

FIG. 5 is a flowchart of a precoding matrix determination method provided in another example of the present disclosure.

FIG. 6 is a flowchart of a precoding matrix determination method provided in yet another example of the present disclosure.

FIG. 7 is a flowchart of a precoding matrix determination method provided in yet another example of the present disclosure.

FIG. 8 is a block diagram of a precoding matrix determination apparatus provided in an example of the present disclosure.

FIG. 9 is a block diagram of a precoding matrix determination apparatus provided in another example of the present disclosure.

FIG. 10 is a block diagram of a user equipment (UE) provided in an example of the present disclosure.

FIG. 11 is a block diagram of a base station provided in an example of the present disclosure.

### DETAILED DESCRIPTION OF THE EMBODIMENTS

Embodiments will be described in detail herein, with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a” and “the” in their singular forms in the examples of the present disclosure and the appended claims are also intended to include their plural forms, unless clearly indicated otherwise in the context. It should also be understood that the term “and/or” as used in the description refers to and includes any and all possible combinations of one or more of the associated listed items.

lₜ is to be understood that, although the terms “first”, “second”, “third”, and the like may be adopted in the examples of the present disclosure to describe various information, the information should not be limited to these terms. These terms are only used to distinguish the information of the same type with each other. For example, without departing from the scope of the present disclosure, first information may be referred to as second information; and similarly, second information may also be referred to as first information. Depending on the context, the word “if” as used herein may be interpreted as “when”, “upon”, or “in response to determining”.

The following describes in detail the examples of the present disclosure. Illustrations of the examples are illustrated in the accompanying drawings, with the same or similar reference numerals referring to the same or similar elements throughout. The examples, which are described below with reference to the accompanying drawings, are illustrated and are intended to explain the present disclosure, but should not be construed as a limitation of the present disclosure.

The precoding matrix determination methods and apparatuses, a user equipment (UE), a base station, and a storage medium provided in the present disclosure will be described in detail with reference to the accompanying drawings.

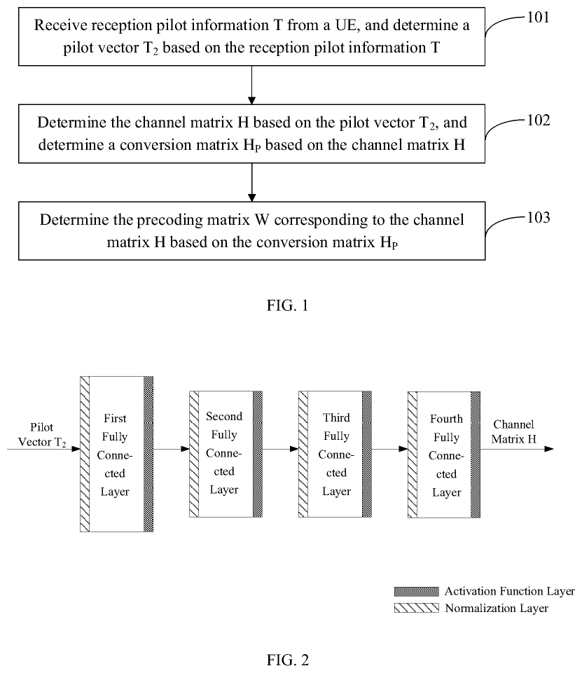

FIG. 1 is a flowchart of a precoding matrix determination method provided in an example of the present disclosure. The method is applied to a base station. As shown in FIG. 1, the precoding matrix determination method can include steps 101 to 103.
Step 101: reception pilot information T is received from a user equipment (UE), and a pilot vector T₂ is determined based on the reception pilot information T.

The method according to the example of the present disclosure can be applied to any UE. The UE can be a device that provides voice and/or data connectivity to a user. The UE can communicate with one or more core networks via a radio access network (RAN). The UE can be an Internet of Things (IoT) terminal, for example, a sensor device, a mobile phone (or a “cellular” phone), and a computer with an IoT terminal. For example, the UE can be a fixed, portable, pocket-sized, handheld, computer built-in, or vehicle-mounted device, for example, a station (STA), a subscriber unit, a subscriber station, a mobile, a remote station, an access point, a remote terminal, an access terminal, a user terminal, or a user agent. Or, the UE can also be a device for an unmanned aerial vehicle. Or, the UE can also be a vehicle-mounted device, for example, a driving computer with a wireless communication function, or a wireless terminal externally connected to a driving computer. Or, the UE can also be a roadside device, for example, a street lamp, a signal lamp or other roadside device with a wireless communication function.

In an example of the present disclosure, the reception pilot information T can be specifically obtained by transmission pilot information P via channel interference when transmitted to the base station. The transmission pilot information P is obtained by processing pilot data s by a first sub-network at the UE end.

Specifically, in an example of the present disclosure, the UE first obtains the pilot data s and processes the pilot data s by using the first sub-network to obtain the transmission pilot information P. Afterwards, the transmission pilot information P is transmitted to the base station, so that the base station can determine the precoding matrix based on the transmission pilot information P.

In an example of the present disclosure, the pilot data s can be pre-agreed by the base station and the UE at a same time-frequency resource. In an example of the present disclosure, the first sub-network at the UE end can specifically include “P” that is P layers of fully connected layers, where P is a positive integer. A dimension of a t-th fully connected layer in the first sub-network is qₜ×1, and qₜ₊₁<qₜ, where qₜ is a positive integer. A dimension of input information of a first fully connected layer of the first sub-network can be 2×K×L×1, where K is a number of UEs corresponding to the base station, and L is a pilot length. A dimension of input information of the last fully connected layer of the first sub-network can be 2×K×L×1.

Further, in an example of the present disclosure, when transmitted to the base station through a channel, the transmission pilot information P will be subject to channel interference, so that the information finally transmitted to the base station becomes the reception pilot information T. The reception pilot information T is related to interference information of the channel (for example, a channel matrix H), so that the base station can subsequently determine the channel matrix H based on the reception pilot information T. Furthermore, based on the channel matrix H, a precoding matrix W is determined, so that when transmitting data later, data to be transmitted will be preprocessed through the precoding matrix W. Thus, the data transmission process can adapt to changes in channel state and improve the performance of data transmission.

In an example of the present disclosure, after receiving the reception pilot information T, the base station will first determine the pilot vector T₂ based on the reception pilot information, so that the channel matrix H can be determined based on the pilot vector T₂ later. Specifically, in an example of the present disclosure, T₂=[Re(T), Im(T); Re(s), Im(s); Pᵤ]; where Re(·) represents taking a real part, and Im(·) represents taking an imaginary part; Pᵤ represents an uplink signal-to-noise ratio.

In addition, it should be noted that, in an example of the present disclosure, the base station can correspond to a plurality of UEs. Each UE corresponds to pilot data s. Each UE can be configured to transmit the transmission pilot information P to the base station, so that the base station receives the reception pilot information T from each UE. Then, based on the reception pilot information T, the channel matrix H corresponding to the channel between each UE and the base station is determined.

Based on this, in an example of the present disclosure, a set of pilot data s corresponding to respective UEs is referred to as a pilot data set S, where S=[s₁, s₂, . . . , s_{K}] ϵ [symbol] ^{L×K}, K is the number of UEs, and s₁, s₂, . . . , s_{K} are orthogonal to each other.

Returning to FIG. 1, step 102: the channel matrix H is determined based on the pilot vector T₂, and a conversion matrix Hₚ is determined based on the channel matrix H.

In an example of the present disclosure, determining the channel matrix H based on the pilot vector T₂ can include: inputting the pilot vector T₂ into a second sub-network to generate the channel matrix H. In an example of the present disclosure, the second sub-network can be a fully connected structure.

The reason why the channel matrix H can be determined based on the pilot vector T₂ by using the second sub-network with a fully connected structure in the present disclosure is explained below.

Specifically, the calculation formula of the channel matrix H in the minimum mean square error (MMSE) algorithm is:

$$H = T {P ( {P}^{H} P + {σ}_{n}^{2} I )}^{- 1}$$

Based on the above formula, when the pilot data s corresponding to respective UEs are orthogonal, the transmission pilot information P of respective UEs will also be orthogonal to each other, and then P^{H}P is a diagonal matrix. In this case, (P^{H}p+σₙ²I)⁻¹ is easy to calculate, so it can be considered that H and (Y; P) are linearly mapped. Therefore, the channel matrix H can be determined based on the pilot vector T₂ by using the second sub-network with a fully connected structure.

Further, in an example of the present disclosure, the second sub-network may include F layers of fully connected layers which are sequentially connected, where F is a positive integer; where a dimension of a t-th fully connected layer of the second sub-network is lₜ×1, where it is a positive integer, l₁≥2×M×N+2×K×L+1, and lₜ₊₁<lₜ, where M is a number of antennas at the base station end, and N is a channel noise. In an example of the present disclosure, a dimension of input data of a first fully connected layer of the second sub-network can be (2×M×N+2×K×L+1)×1. A dimension of output data of the last fully connected layer of the second sub-network can be 2×M×K×1.

Further, it should be noted that, in an example of the present disclosure, the input of each fully connected layer of the second sub-network may have a normalization layer, and the output of each fully connected layer may have an activation function layer. In an example of the present disclosure, activation functions of activation function layers of the first fully connected layer and one or more intermediate fully connected layers of the second sub-network adopt a Rectified Linear Unit (ReLU) function:

$$ReLU ( x ) = \{ \begin{matrix}x , x \geq 0 \\ 0 , x < 0\end{matrix}$$

The activation function of the activation function layer of the last fully connected layer of the second sub-network adopts a LeakyReLU function:

$$LeakyReLU ( x ) = \{ \begin{matrix}x , x \geq 0 \\ 0.3 x , x < 0\end{matrix}$$

Where X is input data of the t-th fully connected layer of the second sub-network.

In an example of the present disclosure, a fully connected operation in the second sub-network can be defined as:

$${y}_{i} = {Σ}_{j} {W}_{i , j} {x}_{i} + {b}_{i}$$

Where, yᵢ is an i-th element output by the second sub-network, W_{i,j} is an (i, j)-th element in a fully connected weight matrix of the second sub-network, bᵢ is an i-th element in a fully connected bias of the second sub-network, and xᵢ is an i-th element input by the second sub-network.

Based on the above description, as an example, FIG. 2 is a schematic structural diagram of a second sub-network provided in an example of the present disclosure. As shown in FIG. 2, the second sub-network includes four fully connected layers, where dimensions of the first fully connected layer, the second fully connected layer, the third fully connected layer, and the fourth fully connected layer are l₁×1, l₂×1, l₃×1, and l₄×1, respectively, where l₁≥2×M×N+2×K×L+1, l₁>l₂>l₃>l₄. Moreover, the input of each fully connected layer also has a normalization layer, and the output of each fully connected layer also has an activation function layer. Activation functions of activation function layers of the first fully connected layer, the second fully connected layer, and the third fully connected layer adopt a ReLU function, and the activation function of the activation function layer of the fourth fully connected layer adopts a LeakyReLU function.

From the included content, it can be seen that the channel matrix H can be generated based on the input pilot vector T₂ by adopting the second sub-network structure.

Further, in an example of the present disclosure, after generating the channel matrix H, the conversion matrix Hₚ can be determined based on the channel matrix H, so as to generate the precoding matrix W based on the conversion matrix Hₚ later.

In an example of the present disclosure, determining the conversion matrix Hₚ based on the channel matrix H may include: inputting the channel matrix H into a third sub-network to generate the conversion matrix Hₚ, where the conversion matrix Hₚ=[Z^{H}H; Z⁺H; H], where Z=(HH^{H}+ρl), ρ is a reciprocal of a downlink signal-to-noise ratio, Z⁺=ZºI, and I is an identity matrix.

The reasons why the channel matrix H is converted into the conversion matrix Hₚ is introduced as follows.

Specifically, in an example of the present disclosure, the calculation formula of the precoding matrix W in the MMSE algorithm is the following formula 1:

$$W = {{H}^{H} ( {HH}^{H} + ρ I )}^{- 1}$$

Where Hϵ [symbol] ^{K×M}. Moreover, since the above calculation formula of the preceding precoding matrix W contains an inverse operation, and the inverse operation is complicated, the relationship between W and H is a nonlinear mapping. Based on this, when directly using the channel matrix H to determine the precoding matrix W, it is necessary to use the nonlinear mapping, which will affect the calculation performance of the precoding matrix W.

On this basis, in order to avoid calculating the precoding matrix W through the nonlinear mapping, in an example of the present disclosure, Z=(HH^{H}+ρl), and since elements at a main diagonal of Z have larger values than elements at other positions, there is the following inverse approximation formula:

$${Z}^{- 1} \approx Z A + {Z}^{+} B + C$$

Where A, B, and C are all learnable parameters that can be trained by the third sub-network.

Based on the above formula 1 and the above inverse approximation formula, the calculation formula of the precoding matrix W can be converted into the following formula 2:

$$W = {H}^{H} {Z}^{- 1} \approx {H}^{H} ( Z A + {Z}^{+} B + C ) = {H}^{H} Z A + {H}^{H} {Z}^{+} B + {H}^{H} C + D$$

Then there is the following formula 3:

$${W}^{H} \approx {A}^{H} {Z}^{H} H + {B}^{H} {Z}^{+} H + {C}^{H} H + D$$

Where A^{H}, B^{H}, C^{H}, and D are learnable parameters that can be trained by the third sub-network.

Based on the above formula 3, it can be determined that the precoding matrix W and [Z^{H}H; Z⁺H; H] are linearly mapped. That is, after determining [Z^{H}H; Z⁺H; H], the precoding matrix W can be directly calculated by the linear mapping. Therefore, in an example of the present disclosure, after determining the channel matrix H, the channel matrix H will be converted into the conversion matrix Hₚ by using the third sub-network, Hₚ=[Z^{H}H; Z⁺H; H], so that the precoding matrix W can be linearly mapped based on the conversion matrix Hₚ later, ensuring the calculation performance.

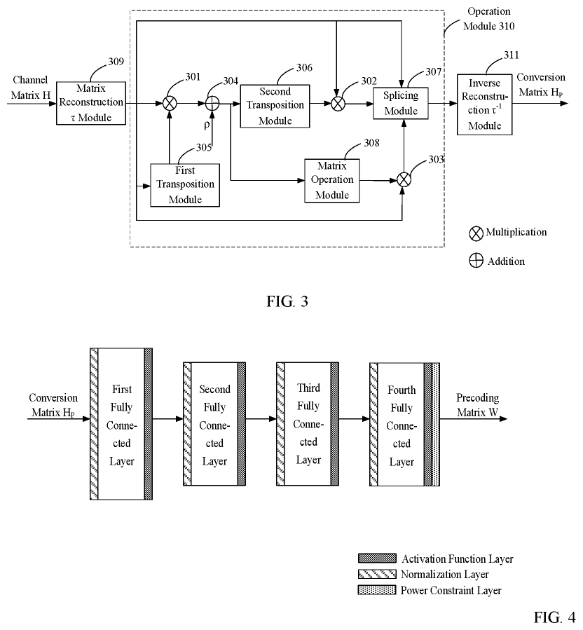

Further, FIG. 3 is a schematic structural diagram of a third sub-network provided in an example of the present disclosure. As shown in FIG. 3, the third sub-network can include a matrix reconstruction T module 309, an operation module 310 and an inverse reconstruction τ⁻¹ module 311 which are sequentially connected.

An input end of the matrix reconstruction T module 309 serves as an input end of the third sub-network, and an output end of the inverse reconstruction τ⁻¹ module 311 serves as an output end of the third sub-network.

Referring further to FIG. 3, in an example of the present disclosure, the operation module 310 may specifically include a first multiplication module 301, a second multiplication module 302, a third multiplication module 303, a first transposition module 305, a second transposition module 306, a splicing module 307, an addition module 304 and a matrix operation module 308.

An output end of the matrix reconstruction T module 309 is respectively connected to a first input end of the first multiplication module 301, an input end of the first transposition module 305, a first input end of the second multiplication module 302, a first input end of the third multiplication module 303, and a first input end of the splicing module 307.

A second input end of the first multiplication module 301 is connected to an output end of the first transposition module 305. An output end of the first multiplication module 301 is connected to an input end of the addition module 304. The addition module 304 is configured to perform an adding ρ operation on input data and output. An output end of the addition module 304 is respectively connected to an input end of the second transposition module 306 and an input end of the matrix operation module 308. The matrix operation module 308 is configured to perform a matrix operation on input data and the identity matrix I and output. In an example of the present disclosure, the matrix operation module 308 is configured to perform Hadamard product operation on the input data and the identity matrix I and output.

An output end of the second transposition module 306 is connected to a second input end of the second multiplication module 302, and an output end of the second multiplication module 302 is connected to a second input end of the splicing module 307. An output end of the matrix operation module 308 is connected to a second input end of the third multiplication module 303, and an output end of the third multiplication module 303 is connected to a third input end of the splicing module 307. An output end of the splicing module 307 is connected to an input end of the inverse reconstruction τ⁻¹ module 311.

Referring to the above content and FIG. 3, it can be seen that when the channel matrix H passes through the third sub-network, the third sub-network will output the conversion matrix Hₚ.

In returning in FIG. 1, step 103: the precoding matrix W corresponding to the channel matrix H is determined based on the conversion matrix Hₚ.

In an example of the present disclosure, determining the precoding matrix W corresponding to the channel matrix H based on the conversion matrix Hₚ can include: inputting the conversion matrix Hₚ into a fourth sub-network to generate the precoding matrix W, where

$$W = {Z}^{- 1} H \approx ( A Z + B {Z}^{+} + C ) H = AZH + {BZ}^{+} H + C H + D$$

Where A, B, C, and D are learnable parameters.

In an example of the present disclosure, referring to the above formulas, it can be obtained that based on the fact that Hₚ→W is a linear mapping, the fourth sub-network can be a fully connected structure, and the linear mapping from the conversion matrix Hₚ to the precoding matrix W can be realized.

Specifically, in an example of the present disclosure, the fourth sub-network can include G layers of fully connected layers which are sequentially connected, where G is a positive integer; where a dimension of a t-th fully connected layer of the fourth sub-network is fₜ×1, where fₜ is a positive integer, f₁>3×6×M×K, fₜ₊₁<fₜ. In an example of the present disclosure, a dimension of input data of a first fully connected layer of the fourth sub-network can be 6×M×K. A dimension of output information of the last fully connected layer of the fourth sub-network can be 2×M×K.

It should be noted that, in an example of the present disclosure, the input of each fully connected layer of the fourth sub-network may have a normalization layer, and the output of each fully connected layer may have an activation function layer. In an example of the present disclosure, activation functions of activation function layers of the first fully connected layer and one or more intermediate fully connected layers of the fourth sub-network adopt a ReLU function:

$$ReLU ( x ) = \{ \begin{matrix}x , & x \geq 0 \\ 0 , & x < 0\end{matrix}$$

The activation function of the activation function layer of the last fully connected layer of the fourth sub-network adopts a Tanh function:

$$Tan h ( x ) = \frac{{e}^{x} - {e}^{- x}}{{e}^{x} + {e}^{- x}}$$

Where X is input data of the t-th fully connected layer of the fourth sub-network.

In an example of the present disclosure, a power constraint layer is also provided outside the activation function layer of the last fully connected layer in the fourth sub-network to ensure that the output precoding matrix can meet the transmission power constraint.

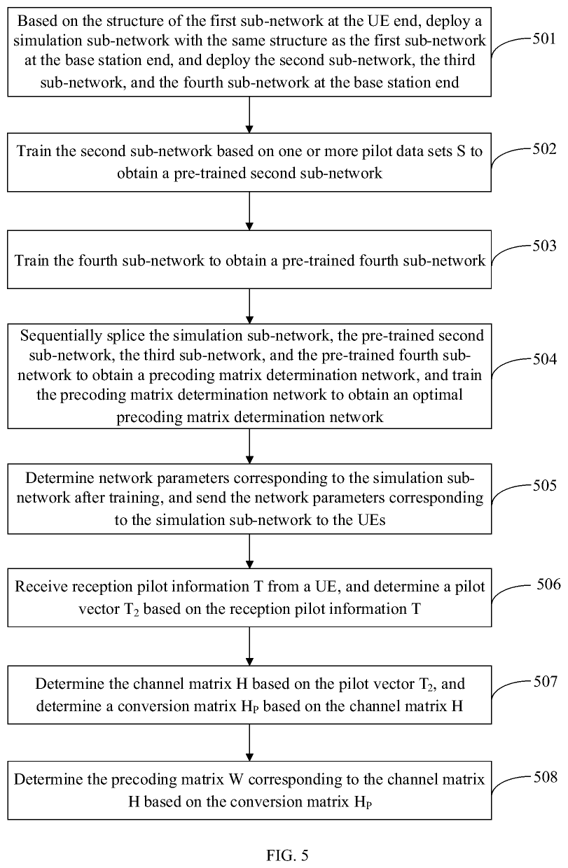

Based on the above description, as an example, FIG. 4 is a schematic structural diagram of a fourth sub-network provided in an example of the present disclosure. As shown in FIG. 4, the fourth sub-network includes four fully connected layers, where dimensions of the first fully connected layer, the second fully connected layer, the third fully connected layer, and the fourth fully connected layer are f₁×1, f₂×1, f₃×1, f₄×1, respectively, where f₁>3×6×M×K, f₁>f₂>f₃>f₄. Moreover, the input of each fully connected layer also has a normalization layer, and the output of each fully connected layer also has an activation function layer. Activation functions of activation function layers of the first fully connected layer, the second fully connected layer, and the third fully connected layer of the fourth sub-network adopt a ReLU function, and the activation function of the activation function layer of the fourth fully connected layer adopts a LeakyReLU function. In addition, a power constraint layer is also provided outside the activation function layer of the fourth fully connected layer.

From the above content, it can be seen that the precoding matrix W can be generated based on the input conversion matrix Hₚ by adopting the fourth sub-network structure.

To sum up, in the precoding matrix determination method provided in the examples of the present disclosure, the base station will first receive the reception pilot information T from the UE, and determine the pilot vector T₂ based on the reception pilot information T. Then, the channel matrix H is determined based on the pilot vector T₂. Finally, the conversion matrix Hₚ is determined based on the channel matrix H, and the precoding matrix W is determined based on the conversion matrix Hₚ. That is, in the examples of the present disclosure, the mapping relationship between the pilot vector T₂ and the precoding matrix W is learned, and based on this mapping relationship, the precoding matrix W is determined based on the pilot vector T₂ by using an implicit channel estimation technology, which can ensure the precoding performance.

In addition, in the examples of the present disclosure, the precoding matrix W is not directly determined based on the channel matrix H. Instead, the conversion matrix Hₚ which is more informative and linearly mapped with the precoding matrix W is first determined based on the channel matrix H, and then the precoding matrix H is linearly mapped based on the conversion matrix Hₚ, so that the determination of the precoding matrix has certain interpretability, the calculation performance is ensured, and a better precoding matrix can be obtained. In addition, the method in the examples of the present disclosure is concise and low in complexity.

FIG. 5 is a flowchart of a precoding matrix determination method provided in another example of the present disclosure. The method is applied to a base station. As shown in FIG. 5, the method may include steps 501 to 508.
Step 501: based on the structure of the first sub-network at the UE end, a simulation sub-network with the same structure as the first sub-network is deployed at the base station end, and the second sub-network, the third sub-network, and the fourth sub-network are deployed at the base station end.

The specific structure of the simulation sub-network can be found in the related introduction of the first sub-network in the included examples. The specific structures of the second sub-network, the third sub-network, and the fourth sub-network can also be found in the specific introduction in the included examples. The embodiment of the present disclosure will not be repeated herein.
Step 502: the second sub-network is trained based on one or more pilot data sets S to obtain a pre-trained second sub-network.

In an example of the present disclosure, the pilot data set S=[s₁, s₂, . . . , s_{K}]∈ [symbol] ^{L×K}, where s_{K} is pilot data of a K-th UE corresponding to the base station, and s₁, s₂, . . . , s_{K} are orthogonal to each other.

In an example of the present disclosure, training the second sub-network based on the pilot data sets S to obtain the pre-trained second sub-network can include Steps A to D, described herein.
Step A: pilot data samples are obtained.

In an example of the present disclosure, N pilot data sets S can be obtained as the pilot data samples.

In an example of the present disclosure, for example, 8 antennas can be configured at the base station end, the base station corresponds to four UEs configured with a single antenna, and 100,000 pilot data sets S generated in a 2.4 GHz outdoor pico cellular scenario can be used as the pilot data samples. The 100,000 pilot data samples can be divided into 90,000 training samples and 10,000 test samples.
Step B: a plurality of training data for training the second sub-network is determined based on the pilot data samples.

In an example of the present disclosure, the training data for training the second sub-network includes a pilot vector T₂. Furthermore, in an example of the present disclosure, determining the training data for training the second sub-network based on the pilot data samples can include: T_{2K}=[Re(T_{K}), Im(T_{K}); Re(s_{K}), Im(s_{K}); Pᵤ], T_{K}=H_{2KSK}+N_{K}, where T_{2K} is a pilot vector determined based on pilot data s_{K} of a K-th UE corresponding to the base station, H_{2K} is an actual channel matrix of a channel between the K-th UE and the base station, and N_{K} is a channel noise of the channel between the K-th UE and the base station.
Step C: the plurality of training data for training the second sub-network is input into the second sub-network to obtain a predicted channel matrix H₁, and a loss function MSE is calculated based on the predicted channel matrix H₁ and an actual channel matrix H₂.

In an example of the present disclosure, the loss function MSE can be:

$$MSE = \frac{1}{2 \times M \times K} {‖ {H}_{2} - {H}_{1} ‖}^{2} = \frac{1}{64} {‖ {H}_{2} - {H}_{1} ‖}^{2}$$

Where ∥·∥ is a Euclidean norm.
Step D: parameters of the second sub-network are updated based on the loss function MSE.

The included Steps A to D are repeated until a minimum loss function is calculated and the training is completed. For example, in an example of the present disclosure, the training times of the second sub-network can be set to 100.

In addition, in an example of the present disclosure, when training the second sub-network, network parameters are set as follows: Adam optimizer, initial learning rate of 0.01, dynamic learning rate change strategy, and saving a model strategy based on test sets.
Step 503: the fourth sub-network is trained to obtain a pre-trained fourth sub-network.

In an example of the present disclosure, training the fourth sub-network based on the pilot data sets S to obtain the pre-trained fourth sub-network can include steps 1 to 3.
Step 1: a conversion matrix H_{pK} corresponding to the actual channel matrix of the channel between the K-th UE and the base station is obtained.

In an example of the present disclosure, the actual channel matrix H_{2K} of the channel between the K-th UE and the base station is determined, and based on the actual channel matrix H_{2K}, the conversion matrix H_{pK} corresponding to the actual channel matrix of the channel between the K-th UE and the base station is determined.
Step 2: the conversion matrix H_{pK} is input into the fourth sub-network to generate a predicted precoding matrix W_{K} corresponding to the channel between the K-th UE and the base station, and a loss function Loss is calculated based on the predicted precoding matrix W_{K}.

In an example of the present disclosure, the loss function Loss can be:

$$Loss = - {\sum }_{k = 1}^{K} ln ( 1 + \frac{{\vert {H}_{2 k}^{H} {w}_{k} \vert}^{2}}{{\sum }_{p = 1 , p \neq k}^{K} {\vert {H}_{2 k}^{H} {w}_{p} \vert}^{2} + {σ}^{2}} )$$

Where σ² is a power of the channel noise of the channel between the UE and the base station.
Step 3: parameters of the fourth sub-network are updated based on the loss function Loss.

The included steps 1 to 3 are repeated until a minimum loss function is calculated and the training is completed. For example, in an example of the present disclosure, the training times of the fourth sub-network can be set to 100.

In addition, in an example of the present disclosure, when training the fourth sub-network, network parameters are set as follows: Adam optimizer, initial learning rate of 0.01, dynamic learning rate change strategy, and saving a model strategy based on test sets.

The channel matrices mentioned in the examples of the present disclosure can all be considered as channel matrices corresponding to a perfect channel.
Step 504: the simulation sub-network, the pre-trained second sub-network, the third sub-network, and the pre-trained fourth sub-network are sequentially spliced to obtain a precoding matrix determination network, and the precoding matrix determination network is trained based on the pilot data sets S to obtain an optimal precoding matrix determination network.

In an example of the present disclosure, when training the precoding matrix determination network, network parameters are set as follows: Adam optimizer, initial learning rate of 0.01, dynamic learning rate change strategy, saving a model strategy based on test sets, a number of training iterations is 100, and the loss function is the above Loss function.

In the process of training the precoding matrix determination network, an input of the simulation sub-network is pilot data s and an output is transmission pilot information P. After that, the precoding matrix determination network will learn the process of “determining reception pilot information T based on the transmission pilot information P, and then determining a pilot vector T₂ based on the reception pilot information T” to obtain the pilot vector T₂, and input the pilot vector T₂ into the second sub-network for subsequent training steps.

In addition, it should be noted that in another example of the present disclosure, after obtaining the pilot data sets S, data T₁ can also be determined based on the pilot data sets S, where T₁=[Re(S), Im(S)]∈ [symbol] ^{2KL}. The data T₁ is taken as the input of the simulation sub-network, so that the simulation sub-network outputs the transmission pilot information P to train the precoding matrix determination network.

In an example of the present disclosure, the loss function of the obtained optimal precoding matrix determination network is the smallest, and the total rate sum of the corresponding K UE ends is the largest.
Step 505: network parameters corresponding to the simulation sub-network after training are determined, and the network parameters corresponding to the simulation sub-network are sent to the UEs.

In an example of the present disclosure, when the optimal precoding matrix determination network is determined, the network parameters corresponding to the simulation sub-network in the optimal precoding matrix determination network can be obtained, and the network parameters can be fed back to the UEs through feedback links, so that the UEs can adjust first sub-networks deployed at the UE ends based on the network parameters.

In an example of the present disclosure, after step 505, the optimal precoding matrix determination network can be tested, and then subsequent steps can be performed, that is, a precoding matrix is determined based on the optimal precoding matrix determination network.
Step 506: reception pilot information T is received from a UE, and a pilot vector T₂ is determined based on the reception pilot information T.
Step 507: a channel matrix H is determined based on the pilot vector T₂, and a conversion matrix Hₚ is determined based on the channel matrix H.
Step 508: a precoding matrix W corresponding to the channel matrix H is determined based on the conversion matrix Hₚ.

The detailed introduction of steps 506 to 507 can refer to the description of the included examples, and the embodiment of the present disclosure will not be repeated herein.

Thus, in the precoding matrix determination method provided in the examples of the present disclosure, the base station will first receive the reception pilot information T from the UE, and determine the pilot vector T₂ based on the reception pilot information T. Then, the channel matrix H is determined based on the pilot vector T₂. Finally, the conversion matrix Hₚ is determined based on the channel matrix H, and the precoding matrix W is determined based on the conversion matrix Hₚ. That is, in the examples of the present disclosure, the mapping relationship between the pilot vector T₂ and the precoding matrix W is learned, and based on this mapping relationship, the precoding matrix W is determined based on the pilot vector T₂ by using an implicit channel estimation technology, which can ensure the precoding performance.

In addition, in the examples of the present disclosure, the precoding matrix W is not directly determined based on the channel matrix H. Instead, the conversion matrix Hₚ which is more informative and linearly mapped with the precoding matrix W is first determined based on the channel matrix H, and then the precoding matrix H is linearly mapped based on the conversion matrix Hₚ, so that the determination of the precoding matrix has certain interpretability, the calculation performance is ensured, and a better precoding matrix can be obtained. In addition, the method in the examples of the present disclosure is concise and low in complexity.

In addition, in the examples of the present disclosure, when training the precoding matrix determination network, the second sub-network and the fourth sub-network are independently trained first, and then the precoding matrix determination network as a whole is trained. This ensures that each sub-network learns an optimal state of the entire network on a suboptimal basis, ensuring training accuracy.

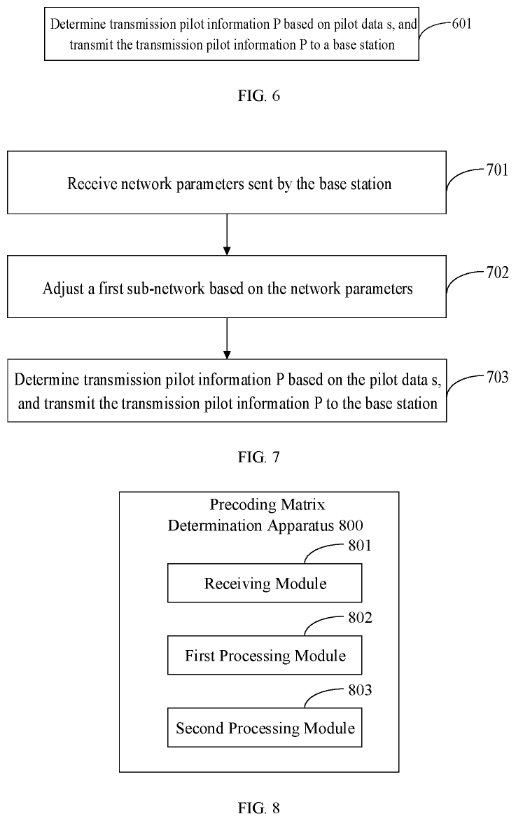

FIG. 6 is a flowchart of a precoding matrix determination method provided in another example of the present disclosure. The method is applied to a UE. As shown in FIG. 6, the precoding matrix determination method can include step 601.
Step 601: transmission pilot information P is determined based on pilot data s, and the transmission pilot information P is transmitted to a base station.

For the detailed introduction of step 601, please refer to the description of the included examples, and the embodiment of the present disclosure will not be repeated herein.

To sum up, in the precoding matrix determination method provided in the examples of the present disclosure, the base station will first receive the reception pilot information T from the UE, and determine the pilot vector T₂ based on the reception pilot information T. Then, the channel matrix H is determined based on the pilot vector T₂. Finally, the conversion matrix Hₚ is determined based on the channel matrix H, and the precoding matrix W is determined based on the conversion matrix Hₚ. That is, in the examples of the present disclosure, the mapping relationship between the pilot vector T₂ and the precoding matrix W is learned, and based on this mapping relationship, the precoding matrix W is determined based on the pilot vector T₂ by using an implicit channel estimation technology, which can ensure the precoding performance.

In addition, in the examples of the present disclosure, the precoding matrix W is not directly determined based on the channel matrix H. Instead, the conversion matrix Hₚ which is more informative and linearly mapped with the precoding matrix W is first determined based on the channel matrix H, and then the precoding matrix H is linearly mapped based on the conversion matrix Hₚ. Thus, the determination of the precoding matrix has certain interpretability, the calculation performance is ensured, and a better precoding matrix can be obtained. In addition, the method in the examples of the present disclosure is concise and low in complexity.

FIG. 7 is a flowchart of a precoding matrix determination method provided in yet another example of the present disclosure. The method is applied to a UE. As shown in FIG. 7, the precoding matrix determination method can include steps 701 to 703.
Step 701: network parameters sent by the base station are received.
Step 702. a first sub-network is adjusted based on the network parameters.
Step 703: transmission pilot information P is determined based on the pilot data s, and the transmission pilot information P is transmitted to the base station.

For the detailed introduction of steps 701-703, please refer to the description of the included examples, and the embodiment of the present disclosure will not be repeated herein.

To sum up, in the precoding matrix determination method provided in the examples of the present disclosure, the base station will first receive the reception pilot information T from the UE, and determine the pilot vector T₂ based on the reception pilot information T. Then, the channel matrix H is determined based on the pilot vector T₂. Finally, the conversion matrix Hₚ is determined based on the channel matrix H, and the precoding matrix W is determined based on the conversion matrix Hₚ. That is, in the examples of the present disclosure, the mapping relationship between the pilot vector T₂ and the precoding matrix W is learned, and based on this mapping relationship, the precoding matrix W is determined based on the pilot vector T₂ by using an implicit channel estimation technology, which can ensure the precoding performance.

In addition, in the examples of the present disclosure, the precoding matrix W is not directly determined based on the channel matrix H. Instead, the conversion matrix Hₚ which is more informative and linearly mapped with the precoding matrix W is first determined based on the channel matrix H, and then the precoding matrix H is linearly mapped based on the conversion matrix Hₚ. Thus, the determination of the precoding matrix has certain interpretability, the calculation performance is ensured, and a better precoding matrix can be obtained. In addition, the method in the examples of the present disclosure is concise and low in complexity.

FIG. 8 is a block diagram of a precoding matrix determination apparatus 800 provided in an example of the present disclosure. As shown in FIG. 8, the apparatus 800 can include a receiving module 801, a first processing module 802, and a second processing module 803.

The receiving module 801 is configured to receive reception pilot information T from a user equipment (UE), and determine a pilot vector T₂ based on the reception pilot information T.

The first processing module 802 is configured to determine a channel matrix H based on the pilot vector T₂, and determine a conversion matrix Hₚ based on the channel matrix H

The second processing module 803 is configured to determine a precoding matrix W corresponding to the channel matrix H based on the conversion matrix Hₚ.

To sum up, in the precoding matrix determination apparatus 800 provided in the examples of the present disclosure, the base station will first receive the reception pilot information T from the UE, and determine the pilot vector T₂ based on the reception pilot information T. Then, the channel matrix H is determined based on the pilot vector T₂. Finally, the conversion matrix Hₚ is determined based on the channel matrix H, and the precoding matrix W is determined based on the conversion matrix Hₚ. That is, in the examples of the present disclosure, the mapping relationship between the pilot vector T₂ and the precoding matrix W is learned, and based on this mapping relationship, the precoding matrix W is determined based on the pilot vector T₂ by using an implicit channel estimation technology, which can ensure the precoding performance.

In addition, in the examples of the present disclosure, the precoding matrix W is not directly determined based on the channel matrix H. Instead, the conversion matrix Hₚ which is more informative and linearly mapped with the precoding matrix W is first determined based on the channel matrix H, and then the precoding matrix H is linearly mapped based on the conversion matrix Hₚ. Thus, the determination of the precoding matrix has certain interpretability, the calculation performance is ensured, and a better precoding matrix can be obtained. In addition, the method in the examples of the present disclosure is concise and low in complexity.

In an example of the present disclosure, the reception pilot information T is obtained by transmission pilot information P via channel interference when transmitted to the base station, and the transmission pilot information P is obtained by processing pilot data s by a first sub-network at the UE, and

$${T}_{2} = [ Re ( T ) , Im ( T ) ; Re ( s ) , Im ( s ) ; {P}_{u} ]$$

Where Re(·) represents taking a real part, and Im(·) represents taking an imaginary part; Pᵤ represents an uplink signal-to-noise ratio.

In an example of the present disclosure, the pilot data s is pre-agreed by the base station and the UE at a same time-frequency resource.

In an example of the present disclosure, the receiving module is further configured to: input the pilot vector T₂ into a second sub-network to generate the channel matrix H.

In an example of the present disclosure, the second sub-network is a fully connected structure. The second sub-network includes F layers of fully connected layers which are sequentially connected, where F is a positive integer; where a dimension of a t-th fully connected layer of the second sub-network is lₜ×1, where lₜ is a positive integer, l₁≥2×M×N+2×K×L+1, and lₜ₊<lₜ, where M is a number of antennas at the base station, K is a number of UEs corresponding to the base station, L is a pilot length, and N is a channel noise.

In an example of the present disclosure, a fully connected operation in the second sub-network is defined as:

$${y}_{i} = {\sum }_{j} {W}_{i , j} {x}_{i} + {b}_{i}$$

Where, yᵢ is an i-th element output by the second sub-network, W_{i,j} is an (i, j)-th element in a fully connected weight matrix of the second sub-network, bᵢ is an i-th element in a fully connected bias of the second sub-network, and xᵢ is an i-th element input by the second sub-network.

In an example of the present disclosure, the first processing module is further configured to: input the channel matrix H into a third sub-network to generate the conversion matrix Hₚ. Where the conversion matrix Hₚ=[Z^{H}H; Z⁺H; H], where Z=(HH^{H}+ρl), ρ is a reciprocal of a downlink signal-to-noise ratio, Z⁺=ZºI, and I is an identity matrix.

In an example of the present disclosure, the third sub-network includes a matrix reconstruction module, an operation module and an inverse reconstruction module which are sequentially connected. Where an input end of the matrix reconstruction module serves as an input end of the third sub-network, and an output end of the inverse reconstruction module serves as an output end of the third sub-network.

In an example of the present disclosure, the operation module includes: a first multiplication module, a second multiplication module, a third multiplication module, a first transposition module, a second transposition module, a splicing module, an addition module and a matrix operation module. Where an output end of the matrix reconstruction module is respectively connected to a first input end of the first multiplication module, an input end of the first transposition module, a first input end of the second multiplication module, a first input end of the third multiplication module, and a first input end of the splicing module. A second input end of the first multiplication module is connected to an output end of the first transposition module, and an output end of the first multiplication module is connected to an input end of the addition module. Where the addition module is configured to perform an adding ρ operation on input data and output. An output end of the addition module is respectively connected to an input end of the second transposition module and an input end of the matrix operation module. Where the matrix operation module is configured to perform a matrix operation on input data and the identity matrix I and output. An output end of the second transposition module is connected to a second input end of the second multiplication module, and an output end of the second multiplication module is connected to a second input end of the splicing module. An output end of the matrix operation module is connected to a second input end of the third multiplication module, and an output end of the third multiplication module is connected to a third input end of the splicing module. An output end of the splicing module is connected to an input end of the inverse reconstruction module.

In an example of the present disclosure, the second processing module is further configured to input the conversion matrix Hₚ into a fourth sub-network to generate the precoding matrix W, where:

$$W = {Z}^{- 1} H \approx ( A Z + B {Z}^{+} + C ) H = AZH + {BZ}^{+} H + C H + D$$

Where A, B, C and D are learnable parameters.

In an example of the present disclosure, the fourth sub-network is a fully connected structure. The fourth sub-network includes G layers of fully connected layers which are sequentially connected. Where G is a positive integer; where a dimension of a t-th fully connected layer of the fourth sub-network is fₜ×1, where fₜ is a positive integer, f₁>3×6×M×K, and fₜ₊₁<fₜ.

In an example of the present disclosure, the apparatus is further configured to train the second sub-network based on one or more pilot data sets S to obtain a pre-trained second sub-network. Where S=[s₁, s₂, . . . , s_{K}]∈ [symbol] ^{L×K}, where s_{K} is pilot data corresponding to a K-th UE, and s₁, s₂, . . . , s_{K} are orthogonal to each other.

In an example of the present disclosure, the apparatus is further configured to train the fourth sub-network to obtain a pre-trained fourth sub-network.

In an example of the present disclosure, the apparatus is further configured to deploy a simulation sub-network at the base station based on a structure of a first sub-network.

In an example of the present disclosure, the apparatus is further configured to sequentially connect the simulation sub-network, the pre-trained second sub-network, the third sub-network and the pre-trained fourth sub-network to obtain a precoding matrix determination network; and train the precoding matrix determination network.

In an example of the present disclosure, the apparatus is further configured to determine network parameters corresponding to the simulation sub-network after training; and send the network parameters to the UE.

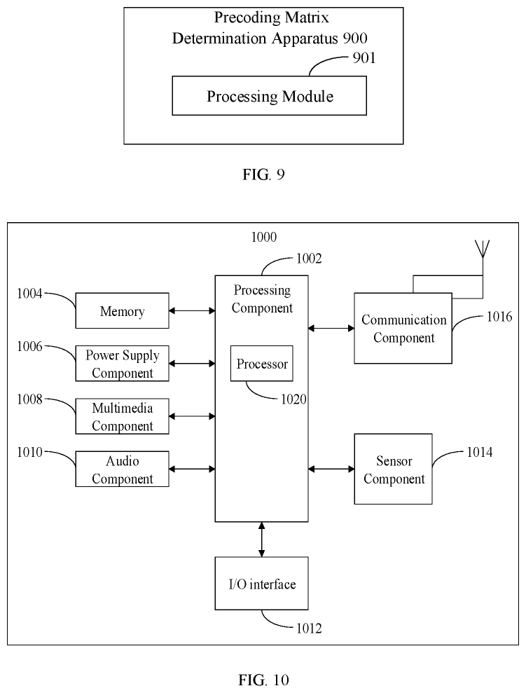

FIG. 9 is a block diagram of a precoding matrix determination apparatus 900 provided in another example of the present disclosure. As shown in FIG. 9, the apparatus 900 can include a processing module 901.

The processing module 901 is configured to determine transmission pilot information P based on pilot data s; and transmit the transmission pilot information P to a base station.

To sum up, in the precoding matrix determination apparatus provided in the examples of the present disclosure, the base station will first receive the reception pilot information T from the UE, and determine the pilot vector T₂ based on the reception pilot information T. Then, the channel matrix H is determined based on the pilot vector T₂. Finally, the conversion matrix Hₚ is determined based on the channel matrix H, and the precoding matrix W is determined based on the conversion matrix Hₚ. That is, in the examples of the present disclosure, the mapping relationship between the pilot vector T₂ and the precoding matrix W is learned. Based on this mapping relationship, the precoding matrix W is determined based on the pilot vector T₂ by using an implicit channel estimation technology, which can ensure the precoding performance.

In addition, in the examples of the present disclosure, the precoding matrix W is not directly determined based on the channel matrix H. Instead, the conversion matrix Hₚ which is more informative and linearly mapped with the precoding matrix W is first determined based on the channel matrix H, and then the precoding matrix H is linearly mapped based on the conversion matrix Hₚ. Thus, the determination of the precoding matrix has certain interpretability, the calculation performance is ensured, and a better precoding matrix can be obtained. In addition, the method in the examples of the present disclosure is concise and low in complexity.

In an example of the present disclosure, the processing module 901 is further configured to input the pilot data s to a first sub-network to output the transmission pilot information P. Where the pilot data s is pre-agreed by the base station and the UE at a same time-frequency resource.

In an example of the present disclosure, the first sub-network is a fully connected structure. The first sub-network includes P layers of fully connected layers, where P is a positive integer; where a dimension of a t-th fully connected layer of the first sub-network is qₜ×1, where qₜ is a positive integer, and qₜ₊₁<qₜ.

In an example of the present disclosure, the apparatus is further configured to receive network parameters sent by the base station; and adjust the first sub-network based on the network parameters sent by the base station.

A computer storage medium provided in an example of the present disclosure stores an executable program. After the executable program is executed by a processor, any method shown in FIG. 1, or FIG. 5, or FIG. 6, or FIG. 7 can be implemented.

In order to implement the included examples, the present disclosure also provides a computer program product, including a computer program that implements any method shown in either FIG. 1, or FIG. 5, or FIG. 6, or FIG. 7 when executed by a processor.

In addition, in order to implement the included examples, the present disclosure also provides a computer program that, when executed by a processor, implements any method shown in FIG. 1, or FIG. 5, or FIG. 6, or FIG. 7.

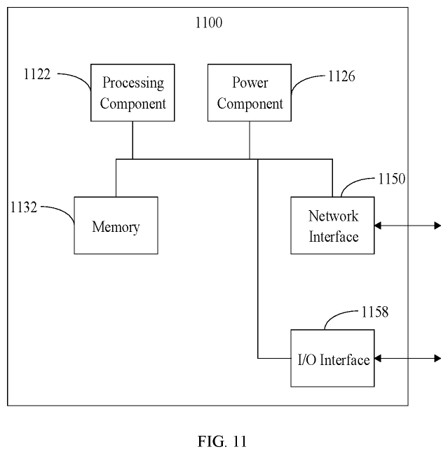

FIG. 10 is a block diagram of a UE 1000 provided by an example of the present disclosure. For example, the UE 1000 may be a mobile phone, a computer, a digital broadcasting terminal equipment, a messaging device, a game console, a tablet device, a medical device, a fitness device, a personal digital assistant, and the like.

By referring to FIG. 10, the UE 1000 may include one or more of the following components: a processing component 1002, a memory 1004, a power supply component 1006, a multimedia component 1008, an audio component 1010, an input/output (I/O) interface 1012, a sensor component 1014, and a communication component 1016.

The processing component 1002 generally controls the overall operations of the UE 1000, such as operations associated with display, phone calls, data communications, camera operations, and recording operations. The processing component 1002 may include at least one processor 1020 to execute instructions to complete all or a part of the steps of the above methods. In addition, the processing component 1002 may include at least one module which facilitates the interaction between the processing component 1002 and other components. For example, the processing component 1002 may include a multimedia module to facilitate the interaction between the multimedia component 1008 and the processing component 1002.

The memory 1004 is configured to store various types of data to support the operations of the UE 1000. Examples of such data include instructions for any application or method operated on the UE 1000, contact data, phonebook data, messages, pictures, videos, and the like. The memory 1004 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 1006 provides power for various components of the UE 1000. The power supply component 1006 may include a power management system, at least one power supply, and other components associated with generating, managing, and distributing power for the UE 1000.

The multimedia component 1008 includes a screen providing an output interface between the UE 1000 and a user. In some examples, the screen may include a liquid crystal display (LCD) and a touch panel (TP). If the screen includes the TP, the screen may be implemented as a touch screen to receive input signals from the user. The TP may include at least one touch sensor to sense touches, swipes, and gestures on the TP. The touch sensor may not only sense a boundary of a touch or swipe, but also sense a lasting time and a pressure associated with the touch or swipe. In some examples, the multimedia component 1008 includes a front camera and/or a rear camera. The front camera and/or rear camera may receive external multimedia data when the UE 1000 is in an operating mode, such as a photographing mode or a video mode. Each front camera and rear camera may be a fixed optical lens system or have focal length and optical zooming capability.

The audio component 1010 is configured to output and/or input an audio signal. For example, the audio component 1010 includes a microphone (MIC) that is configured to receive an external audio signal when the UE 1000 is in an operating mode, such as a call mode, a recording mode, and a voice recognition mode. The received audio signal may be further stored in memory 1004 or transmitted via communication component 1016. In some examples, the audio component 1010 also includes a speaker for outputting an audio signal.

The I/O interface 1012 provides an interface between the processing component 1002 and a peripheral interface module. The above peripheral interface module may be a keyboard, a click wheel, buttons, or the like. These buttons may include but not limited to a home button, a volume button, a start button and a lock button.

The sensor component 1014 includes at least one sensor to provide the UE 1000 with status assessments in various aspects. For example, the sensor component 1014 may detect an open/closed state of the UE 1000 and a relative positioning of components such as a display and a keypad of the UE 1000. The sensor component 1014 may also detect a change in position of the UE 1000 or a component of the UE 1000, the presence or absence of user contact with the UE 1000, orientation or acceleration/deceleration of the UE 1000, and temperature change of the UE 1000. The sensor component 1014 may include a proximity sensor configured to detect the presence of a nearby object without any physical contact. The sensor component 1014 may further include an optical sensor, such as a complementary metal-oxide-semiconductor (CMOS) or charged coupled device (CCD) image sensor which is used in imaging applications. In some examples, the sensor component 1014 may also include an acceleration sensor, a gyro sensor, a magnetic sensor, a pressure sensor, or a temperature sensor.

The communication component 1016 is configured to facilitate wired or wireless communication between the UE 1000 and other devices. The UE 1000 may access a wireless network based on a communication standard, such as WiFi, 2G or 3G, or a combination thereof. In an example, the communication component 1016 receives broadcast signals or broadcast related information from an external broadcast management system via a broadcast channel. In an example, the communication component 1016 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the UE 1000 may be implemented by at least one application specific integrated circuit (ASIC), digital signal processor (DSP), digital signal processing device (DSPD), programmable logic device (PLD), field programmable gate array (FPGA), controller, microcontroller, microprocessor, or another electronic component for performing the above methods.

FIG. 11 is a block diagram of a base station 1100 provided in an example of the present disclosure. For example, the base station 1100 can be provided as a base station. Referring to FIG. 11, the base station 1100 includes a processing component 1122, which further includes at least one processor (not shown) and memory resources represented by a memory 1132 for storing instructions, such as an application program, that can be executed by the processing component 1122. The application program stored in the memory 1132 may include one or more modules, each of which corresponds to a set of instructions. In addition, the processing component 1122 is configured to execute instructions to perform any of the above methods applied to the base station, such as the method shown in FIG. 1.

The base station 1100 may also include a power component 1126 configured to perform power management of base station 1100, a wired or wireless network interface 1150 configured to connect the base station 1100 to a network, and an input output (I/O) interface 1158. The base station 1100 can operate based on an operating system stored in the memory 1132, such as Windows Server™, Mac OS X™, Unix™, Linux™, Free BSD™, or the like. The modules included in apparatuses 800 and 900 of FIGS. 8 and 9 can be performed by the corresponding structure found in FIGS. 10 and/or 11.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the scope and spirit of the present disclosure are to be indicated by appended claims.

It should be understood that the present disclosure is not limited to the above-described accurate structures illustrated in the drawings, and various modifications and changes can be made to the present disclosure without departing from the scope thereof. The scope of the present disclosure is to be limited only by the appended claims.

1. A precoding matrix determination method, performed by a base station, the method comprising:
receiving reception pilot information T from a user equipment (UE);
determining a pilot vector T₂ based on the reception pilot information T;
determining a channel matrix H based on the pilot vector T₂;
determining a conversion matrix He based on the channel matrix H; and
determining a precoding matrix W corresponding to the channel matrix H based on the conversion matrix Hₚ.

2. The method according to claim 1, wherein the reception pilot information T is obtained by transmission pilot information P via channel interference when transmitted to the base station, and the transmission pilot information P is obtained by processing pilot data s by a first sub-network at the UE; or
determining the pilot vector T₂ based on the reception pilot information T comprising:
$${T}_{2} = [ Re ( T ) , Im ( T ) ; Re ( s ) , Im ( s ) ; {P}_{u} ] ;$$
wherein Re(·) represents taking a real part, and Im(·) represents taking an imaginary part; Pᵤ represents an uplink signal-to-noise ratio.

3. The method according to claim 2, wherein the pilot data s is pre-agreed by the base station and the UE at a same time-frequency resource.

4. The method according to claim 1, wherein determining the channel matrix H based on the pilot vector T₂ comprises:
inputting the pilot vector T₂ into a second sub-network to generate the channel matrix H.

5. The method according to claim 4, wherein the method comprises at least one of:
the second sub-network is a fully connected structure;
the second sub-network comprises F layers of fully connected layers which are sequentially connected, wherein F is a positive integer; wherein a dimension of a t-th fully connected layer of the second sub-network is lₜ×1, wherein lₜ is a positive integer, l₁≥2×M×N+2×K×L+1, and lₜ₊₁<lₜ, wherein M is a number of antennas at the base station, K is a number of UEs corresponding to the base station, L is a pilot length, and N is a channel noise; or
a fully connected operation in the second sub-network is defined as:
$${y}_{i} = {\sum }_{j} {W}_{i , j} {x}_{i} + {b}_{i} ;$$
wherein, yᵢ is an i-th element output by the second sub-network, W_{i,j} is an (i, j)-th element in a fully connected weight matrix of the second sub-network, bᵢ is an i-th element in a fully connected bias of the second sub-network, and xᵢ is an i-th element input by the second sub-network.

6. (canceled)

7. The method according to claim 4, wherein determining the conversion matrix Hₚ based on the channel matrix H comprises:
inputting the channel matrix H into a third sub-network to generate the conversion matrix Hₚ, wherein the conversion matrix Hₚ=[Z^{H}H; Z⁺H; H], wherein Z=(HH^{H}+ρl), ρ is a reciprocal of a downlink signal-to-noise ratio, Z⁺=ZºI, and I is an identity matrix.

8. The method according to claim 7,
wherein the third sub-network comprises a matrix reconstruction module, an operation module and an inverse reconstruction module which are sequentially connected; and
wherein an input end of the matrix reconstruction module serves as an input end of the third sub-network, and an output end of the inverse reconstruction module serves as an output end of the third sub-network.

9. The method according to claim 8, wherein the operation module comprises: a first multiplication module, a second multiplication module, a third multiplication module, a first transposition module, a second transposition module, a splicing module, an addition module and a matrix operation module;
wherein an output end of the matrix reconstruction module is respectively connected to a first input end of the first multiplication module, an input end of the first transposition module, a first input end of the second multiplication module, a first input end of the third multiplication module, and a first input end of the splicing module;
a second input end of the first multiplication module is connected to an output end of the first transposition module; an output end of the first multiplication module is connected to an input end of the addition module, wherein the addition module is configured to perform an adding ρ operation on input data and output; an output end of the addition module is respectively connected to an input end of the second transposition module and an input end of the matrix operation module, wherein the matrix operation module is configured to perform a matrix operation on input data and the identity matrix I and output; and
an output end of the second transposition module is connected to a second input end of the second multiplication module, and an output end of the second multiplication module is connected to a second input end of the splicing module; an output end of the matrix operation module is connected to a second input end of the third multiplication module, and an output end of the third multiplication module is connected to a third input end of the splicing module; an output end of the splicing module is connected to an input end of the inverse reconstruction module.

10. The method according to claim 7, wherein determining the precoding matrix W corresponding to the channel matrix H based on the conversion matrix Hₚ comprises:
inputting the conversion matrix Hₚ into a fourth sub-network to generate the precoding matrix W, wherein
$$W = {Z}^{- 1} H \approx ( A Z + B {Z}^{+} + C ) H = AZH + {BZ}^{+} H + C H + D$$
wherein A, B, C and D are learnable parameters.

11. The method according to claim 10, wherein the fourth sub-network is a fully connected structure;
the fourth sub-network comprises G layers of fully connected layers which are sequentially connected, wherein G is a positive integer; wherein a dimension of a t-th fully connected layer of the fourth sub-network is fₜ×1, wherein fₜ is a positive integer, f₁>3×6×M×K, and fₜ₊₁<fₜ, wherein M is a number of antennas at the base station, and wherein K is a number of UEs corresponding to the base station.

12. The method according to claim 10, further comprising:
training the second sub-network based on one or more pilot data sets S to obtain a pre-trained second sub-network;
wherein S=[s₁, s₂, . . . , s_{K}]∈ [symbol] ^{L×K}, wherein s_{K} is pilot data corresponding to a K-th UE, s₁, s₂, . . . , s_{K} are orthogonal to each other, and L is a pilot length.

13. The method according to claim 12, further comprising:
training the fourth sub-network to obtain a pre-trained fourth sub-network.

14. The method according to claim 13, further comprising:
deploying a simulation sub-network at the base station based on a structure of a first sub-network at the UE, wherein a structure of the simulation sub-network is the same as the structure of the first sub-network.

15. The method according to claim 14, further comprising:
sequentially connecting the simulation sub-network, the pre-trained second sub-network, the third sub-network and the pre-trained fourth sub-network to obtain a precoding matrix determination network; and
training the precoding matrix determination network.

16. The method according to claim 15, further comprising:
determining network parameters corresponding to the simulation sub-network after training; and
sending the network parameters to the UE.

17. A precoding matrix determination method, performed by a user equipment (UE), the method comprising:
determining transmission pilot information P based on pilot data s; and
transmitting the transmission pilot information P to a base station.

18. The method according to claim 17, wherein determining the transmission pilot information P based on the pilot data s comprises:
inputting the pilot data s to a first sub-network to output the transmission pilot information P; wherein the pilot data s is pre-agreed by the base station and the UE at a same time-frequency resource.

19. The method according to claim 18, wherein the method comprises at least one of:
the first sub-network is a fully connected structures, and
the first sub-network comprises P layers of fully connected layers, wherein P is a positive integer; wherein a dimension of a t-th fully connected layer of the first sub-network is qₜ×1, wherein qₜ is a positive integer, and qₜ₊₁<qₜ; or
receiving network parameters sent by the base station, and
adjusting the first sub-network based on the network parameters sent by the base station.

20-22. (canceled)

23. A user equipment (UE), comprising:
a transceiver;
a memory; and
a processor, respectively communicatively connected to the transceiver and the memory, configured to control wireless signal transmission and reception of the transceiver by executing computer executable instructions on the memory, and capable of implementing the method according to claim 17.

24. A base station, comprising:
a transceiver;
a memory; and
a processor, respectively communicatively connected to the transceiver and the memory, configured to execute computer executable instructions on the memory to control wireless signal transmission and reception of the transceiver and perform operations comprising:
receiving reception pilot information T from a user equipment (UE);
determining a pilot vector T, based on the reception pilot information T;
determining a channel matrix H based on the pilot vector T₂;
determining a conversion matrix He based on the channel matrix H; and
determining a precoding matrix W corresponding to the channel matrix H based on the conversion matrix Hₚ.

25. (canceled)
